(19) United States
(12) Patent Application Publication
(10) Pub. No.: US 2005/0184195 A1
(43) Pub. Date: Aug. 25, 2005

(54) High vertical rescue method and apparatus

(76) Inventor: Jeffrey J. Jonas, Las Vegas, NV (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/026,722

(22) Filed: Dec. 30, 2004

Related U.S. Application Data
(60) Provisional application No. 60/533,706, filed on Dec. 31, 2003.

(51) Int. Cl. B64D 1/08

(52) U.S. Cl. 244/137.2

(57) ABSTRACT

A method and apparatus for rescuing an object is disclosed. The apparatus comprises a boom having a first end and a second end and an attachment mechanism for attaching the boom first end to an aircraft. The attachment mechanism includes a pivot mechanism for moving the boom between a set, a non-vertical orientation and a released, more vertical orientation generally below the aircraft). The apparatus further includes a capture device that attaches to the boom second end for receiving the object when the boom is in the set orientation.

### CROSS-REFERENCE TO RELATED APPLICATIONS

The present application claims the benefit of provisional patent application number 60/533,706, filed in the United States Patent and Trademark Office on Dec. 31, 2003.

### FEDERALLY SPONSORED RESEARCH OR DEVELOPMENT

Not Applicable.

### TECHNICAL FIELD

This invention generally relates to a method and apparatus for rescuing an object, such as a natural person and/or property, and more particularly, to a method and apparatus for rescuing the object from a raised structure, such as a high rise building, utilizing an extension attached to an aircraft extending a capture device in a non-vertical orientation.

### BACKGROUND OF THE INVENTION

Emergency personnel (e.g., firefighters, armed forces, police officers, health care personnel) use various means to identify, secure, release, or otherwise rescue an object in the midst of emergency situations (e.g., fires, robberies, combat).

In response to any emergency situation, such as in the event of a fire in a tall building, the emergency personnel use a variety of means to rescue the object. For example, in the event of a fire in an 18-story building, firefighters use: (a) ladders that can extend approximately one hundred feet reaching the objects at the lower half of the building, (b) stairwells in the building to identify and remove the objects throughout the building, although the stairwells have limited use depending upon the nature and timing of the emergency situation, (c) nets extended near the ground for the objects to jump or otherwise be dropped or released into, although the nets are generally limited to objects at heights less than thirty (30) feet, given, at a minimum, the adverse effects of the fall, (d) a net slide (e.g., sock) emanating from a portion of the building to the ground and (e) helicopters or other aircraft enabling firefighters to land on the top of buildings. In the event of water, mountainous or other similar situations wherein the objects are below aircraft (e.g., helicopter), the emergency personnel can use safety nets attached to the bottom of the aircraft to secure the objects and transport the objects to a more stable situation.

However, certain aircraft (e.g., helicopters or other hovering aircraft) cannot be used to rescue objects in a high vertical building, cliff, or other raised structure (whether in nature or otherwise constructed) in the same manner as a water rescue or a mountainous rescue because the blades of the aircraft extend in a manner that a capture device (e.g., net, balloon, harness, or other device utilized to secure the object) cannot reach the object on the side of the raised structure. Furthermore, the weight of objects that are held out beyond the blades of the aircraft in the capture device will cause the aircraft to veer into the raised structure.

As such, emergency personnel often cannot rescue objects that are in high raised structures or other circumstances that cause the objects to be parallel to the aircraft, such as the upper portion of a burning building.

The present invention is provided to address these and other issues.

### BRIEF DESCRIPTION OF THE DRAWINGS

FIG. 1 is a functional drawing of an apparatus for rescuing an object from a raised structure, such as a high-rise building, in accordance with the invention.

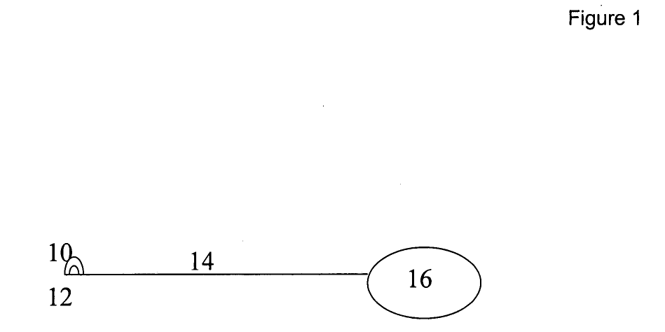

FIG. 2 is a functional drawing of the apparatus of FIGURE attached to an aircraft.

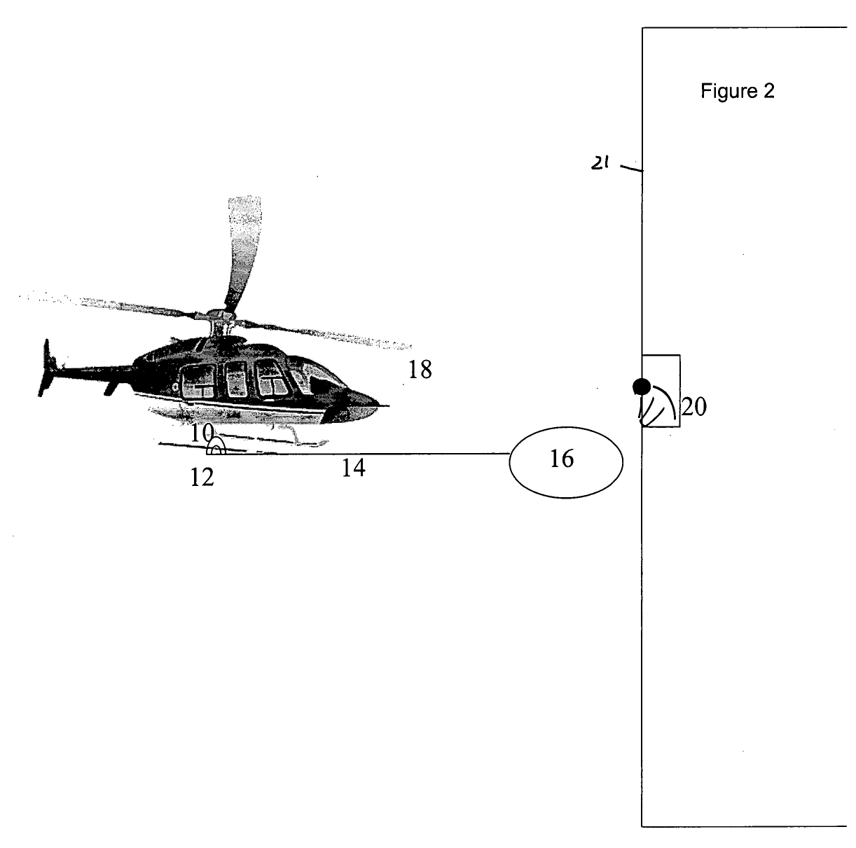

FIG. 3 is a functional drawing of the apparatus of FIG. 1 when an object enters a capture device.

FIG. 4 is a functional drawing of the apparatus of FIG. 1 after an attachment mechanism is released enabling the capture device to move below the aircraft.

FIG. 5 is a functional drawing of an alternative embodiment of the apparatus for rescuing an object from a raised structure in accordance with the invention.

FIG. 6 is a functional drawing of a further alternative embodiment of the apparatus for rescuing an object from a raised structure in accordance with the invention.

FIG. 7 is a functional drawing of a still further alternative embodiment of the apparatus for rescuing an object from a raised structure in accordance with the invention.

### DETAILED DESCRIPTION OF THE INVENTION

While this invention is susceptible of embodiment in many different forms, there is shown in the drawing, and will be described herein in detailed, specific embodiments thereof with the understanding that the present disclosure is to be considered as an exemplification of the principles of the invention and is not intended to limit the invention to the specific embodiments illustrated.

An apparatus for rescuing an object 20, such as a natural person or property, from a raised structure 21, such as a high rise building, a cliff or other structure, natural or otherwise, is illustrated in the FIGURES. The apparatus is attached to an aircraft 18 and comprises a boom 14, such as a cable, pole, spar, extension or the like. The boom 14 has a first boom end 14a and a second boom end 14b. The apparatus further includes an attachment mechanism 10 for attaching the first boom end 14a to the aircraft 18. The attachment mechanism 10 includes a pivot mechanism 12 for moving the boom 14 between a set position and a released position. When in the set position, the boom 14 is in a non-vertical orientation, such as perpendicular to or angled from the aircraft 18, extending the second boom end 14b beyond the propeller of the aircraft 18. When in the released position, the boom 14 is in a more vertical orientation securing the boom 14 below the aircraft 18.

The apparatus also comprises a capture device 16 that attaches to the second boom end 14b. The capture device receives the object 20 when the boom 14 is in the set position.

The apparatus enables the object 20 to transfer to, or be transferred to, such as by jumping, the capture device 16 and to be transported to a more secure area.

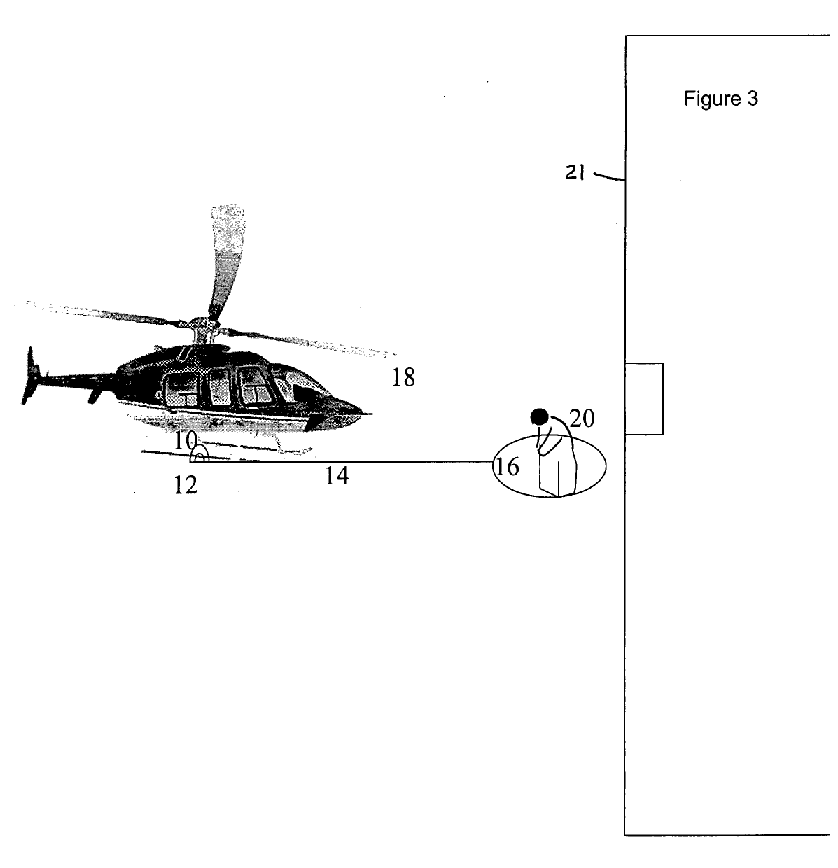

As illustrated in FIG. 3, when the object 20 is in the capture device 16, the capture device 16 envelops or otherwise secures the object 20, such as within a net.

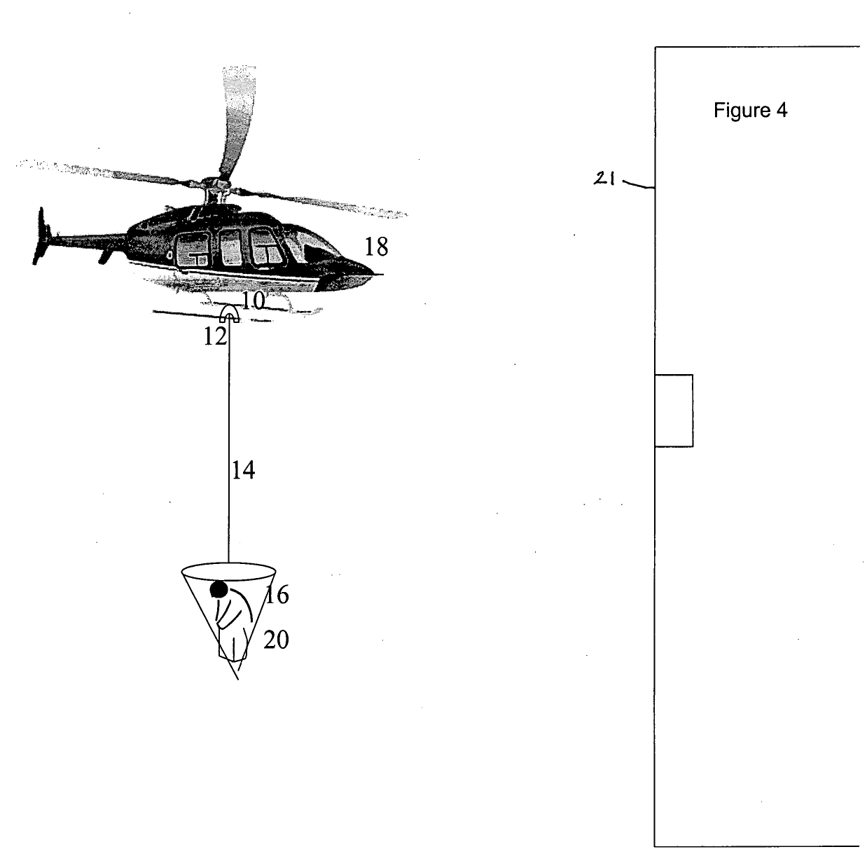

As illustrated in FIG. 4, the pivot mechanism 12 is triggered, such as by the weight of the object 20 or by an aircraft operator, to release the boom 14 from the set position to the released position to move the capture device 16 with the object 20 secured in the capture device below the aircraft 18. The aircraft 18 can then transport the object 20 to a more stable situation, release the object 20 from the capture device 16 and reset the apparatus to rescue additional objects. The capture device 16 includes a leveling mechanism to maintain the capture device 16 in a substantially vertical orientation as the boom 14 moves from the set position to the released position.

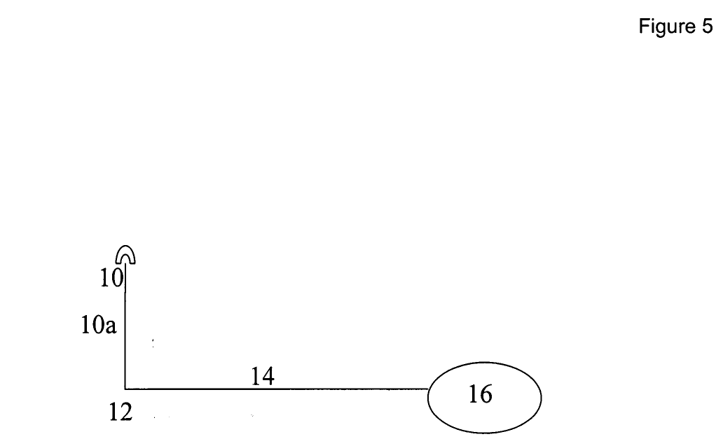

Another embodiment is illustrated in FIG. 5. In this embodiment, the attachment mechanism 10 includes an extension 10a between the aircraft 18 and the pivot mechanism 12.

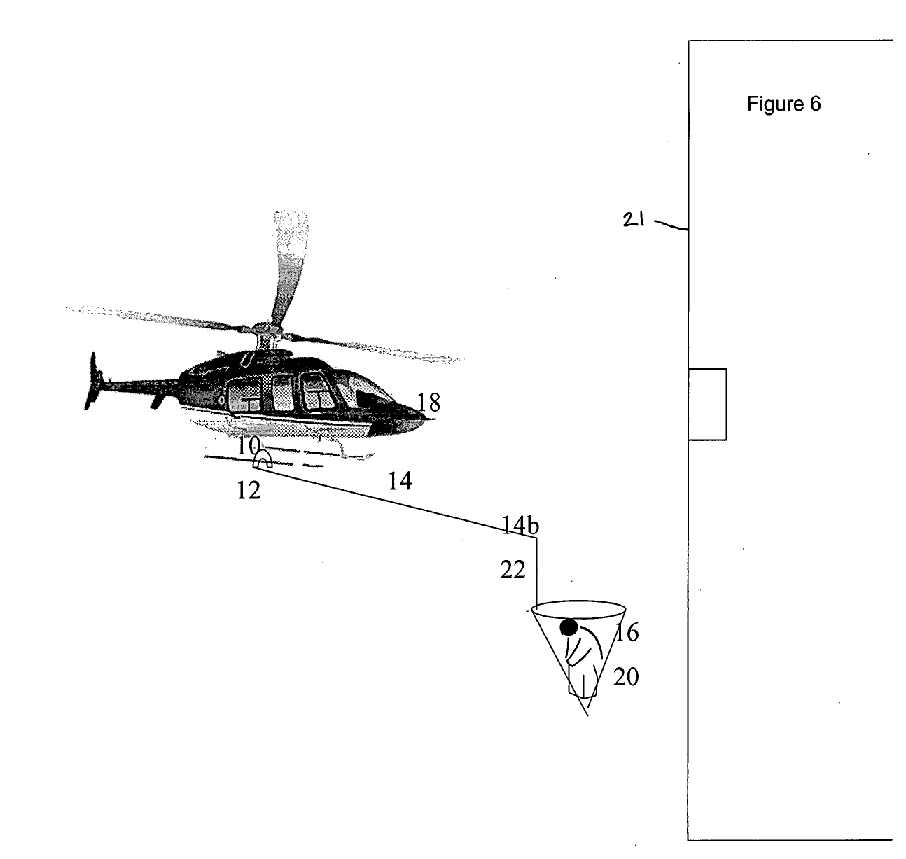

A further embodiment is illustrated in FIG. 6. In this embodiment, the capture device 16 is connected to the second boom end 14b with an elastic mechanism 22, such as an elastic or bungee cord extension soften or otherwise minimize any adverse impact when the object 20 is secured in the capture device 16.

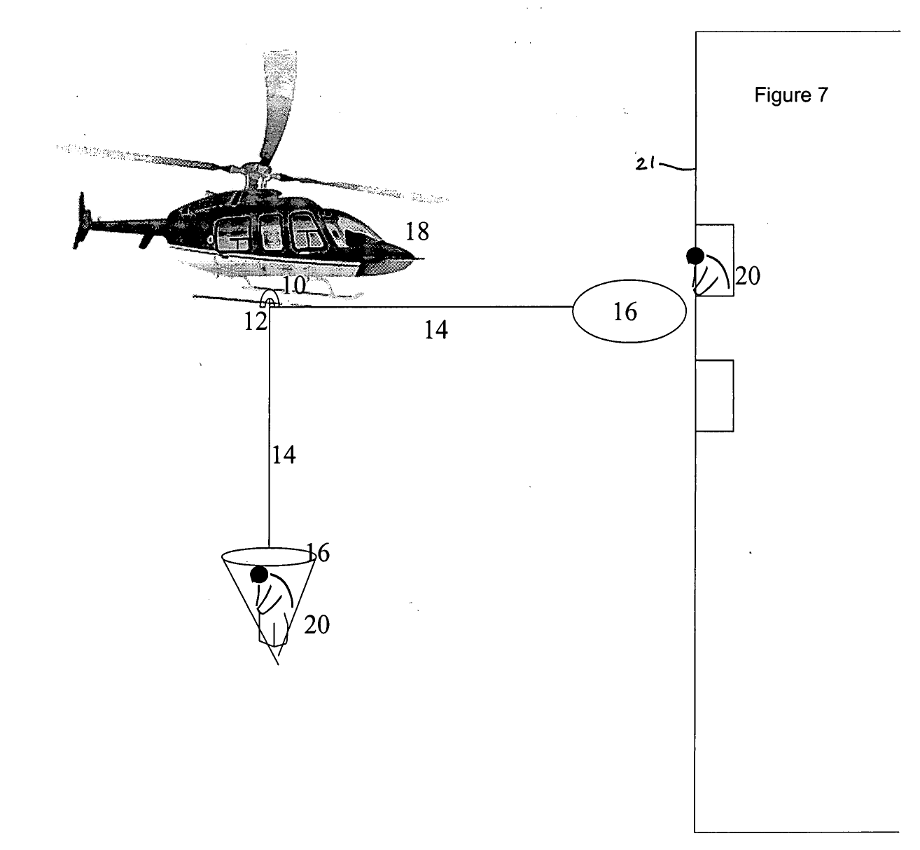

A still further embodiment is illustrated in FIG. 7. In this embodiment, the apparatus includes a plurality of booms 14, each having a respective one of the capture devices 16 per aircraft 18. In this embodiment, a second of the plurality of booms 14 will be set after the pivot mechanism 12 releases the first of the plurality of booms 14.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An apparatus for rescuing an object from a raised structure comprising:
a boom having a first end and a second end;
an attachment mechanism for attaching the boom first end to an aircraft, the attachment mechanism including a pivot mechanism for moving the boom between a non-vertical orientation and a more vertical orientation; and
a capture device for receiving the object when the boom is in the non-vertical orientation, the capture device being attached to the boom second end.

2. The apparatus of claim 1 wherein the attachment mechanism includes an extension between the aircraft and the pivot mechanism.

3. The apparatus of claim 1 wherein the capture device comprises a net.

4. The apparatus of claim 1 wherein the pivot mechanism releases the boom from the non-vertical orientation to the more vertical orientation upon receipt of the object in the capture device.

5. The apparatus of claim 4 wherein the capture device includes a leveling mechanism to maintain the capture device in a substantially vertical orientation as the boom moves from the non-vertical orientation to the more vertical orientation.

6. The apparatus of claim 1 including an elastic mechanism connecting the boom to the capture device.

7. The apparatus of claim 1 wherein the non-vertical orientation is a substantially horizontal orientation.

8. A method for rescuing an object from a raised structure comprising:
providing an aircraft;
providing a boom having a first end attached to the aircraft and a second end attached to a capture device;
positioning the boom from the aircraft in a non-vertical orientation;
locating the capture device adjacent the object;
receiving the object in the capture device; and
positioning the boom in a more vertical orientation.

9. The method of claim 8 wherein the capture device includes a net.

10. The method of claim 8 including providing an elastic mechanism to couple the boom to the capture device.

11. The method of claim 8 wherein the positioning of the boom from the non-vertical orientation to the more vertical orientation occurs upon receipt of the object by the capture device.

12. The method of claim 8 wherein the non-vertical orientation is a substantially horizontal position.
